(19) United States
(12) Patent Application Publication
(10) Pub. No.: US 2016/0332603 A1
(43) Pub. Date: Nov. 17, 2016

(54) WASHING SYSTEM FOR VEHICLES WITH AUTOMATIC SHUTOFF BASED ON VEHICLE SPEED

(71) Applicant: Belanger, Inc., Northville, MI (US)

(72) Inventor: Adam Michael Kelsey, Northville, MI (US)

(21) Appl. No.: 15/152,837

(22) Filed: May 12, 2016

Related U.S. Application Data
(60) Provisional application No. 62/161,675, filed on May 14, 2015.

(51) Int. Cl. B60S 3/04; B60S 3/00; G08G 1/08; G07C 5/00

(52) U.S. Cl. CPC B60S 3/04; G07C 5/008; B60S 3/004; G08G 1/08

(57) ABSTRACT

A vehicle wash system includes a plurality of vehicle treatment components and at least one sensing mechanism each in communication with a controller. The controller including a stored vehicle speed threshold and configured to implement a control action if an actual vehicle speed meets the vehicle speed threshold.

### CROSS-REFERENCE TO RELATED APPLICATIONS

The present application claims priority to U.S. Provisional Patent Application Ser. No. 62/161,675, filed May 14, 2015, and entitled “Washing System for Vehicles with Automatic Shutoff Based on Vehicle Speed”, which is hereby incorporated by reference as though set forth fully herein.

### TECHNICAL FIELD

The present disclosure relates generally to a washing system for vehicles and a method of operating a washing system for vehicles. More specifically, the present disclosure relates to a washing system for fleet operators that minimizes damage to the wash components as well as vehicles subjected to same.

### BACKGROUND OF THE DISCLOSURE

Washing systems are commonly used by owners of fleet vehicles (e.g. rental car companies, trucking companies, etc.) to keep vehicles in their fleet clean. In operation, porters are generally tasked with the responsibility of shuttling vehicles to refuel them and wash them after each use to ready them for their next use in fleet operations. Porters are usually expected to quickly and efficiently refuel, wash, and move the vehicles, and may even be compensated based on the number of vehicles they process in a day. Porters may therefore be inclined to attempt to move a vehicle through a washing system at a high rate of speed.

However, the numerous moving components (e.g. rollers, sprayers, wheels) included in most washing systems can be damaged if a vehicle is moved through a washing system too quickly. Additionally, the paint, exterior trim and exterior accessories of a vehicle may also be damaged if the vehicle goes through a washing system at an excessive speed. As a result, porters or other drivers moving a vehicle through a washing system at an excessive speed may damage the washing system and/or the vehicle in the process of washing it. Accordingly, there is an increasing need for improved washing systems for vehicles.

### SUMMARY OF THE DISCLOSURE

It is therefore an aspect of the present disclosure to provide a vehicle wash system for use by owners of fleet vehicles.

It is another aspect of the present disclosure to provide a vehicle wash system that can minimize damage to vehicles driven through the wash system.

It is still another aspect of the present disclosure to provide a vehicle wash system that can prolong the life of its vehicle treatment components.

It is a further aspect of the present disclosure to provide a vehicle wash system that provides improved control over the wash process.

In accordance with the above and the other aspects of the present disclosure a vehicle wash system is provided. The vehicle wash system includes a control system in communication with a plurality of vehicle wash components disposed adjacent a vehicle treatment area. The system also includes at least one detection mechanism located adjacent the vehicle treatment area for obtaining vehicle data and communicating that to the control system. The control system determines an actual vehicle speed and compares that to a predetermined vehicle speed threshold stored on the control system. If the actual vehicle speed meets or exceeds the predetermined vehicle speed threshold, the control system implements a predetermined control action.

### BRIEF DESCRIPTION OF THE DRAWINGS

Other aspects of the present disclosure will be readily appreciated, as the same becomes better understood by reference to the following detailed description when considered in connection with the accompanying drawings wherein:

FIG. 1 is a block diagram of a washing system according to an aspect of the disclosure; and

FIG. 2 is a flowchart of a method of operating a washing system according an aspect of the disclosure.

### DETAILED DESCRIPTION OF THE DISCLOSURE

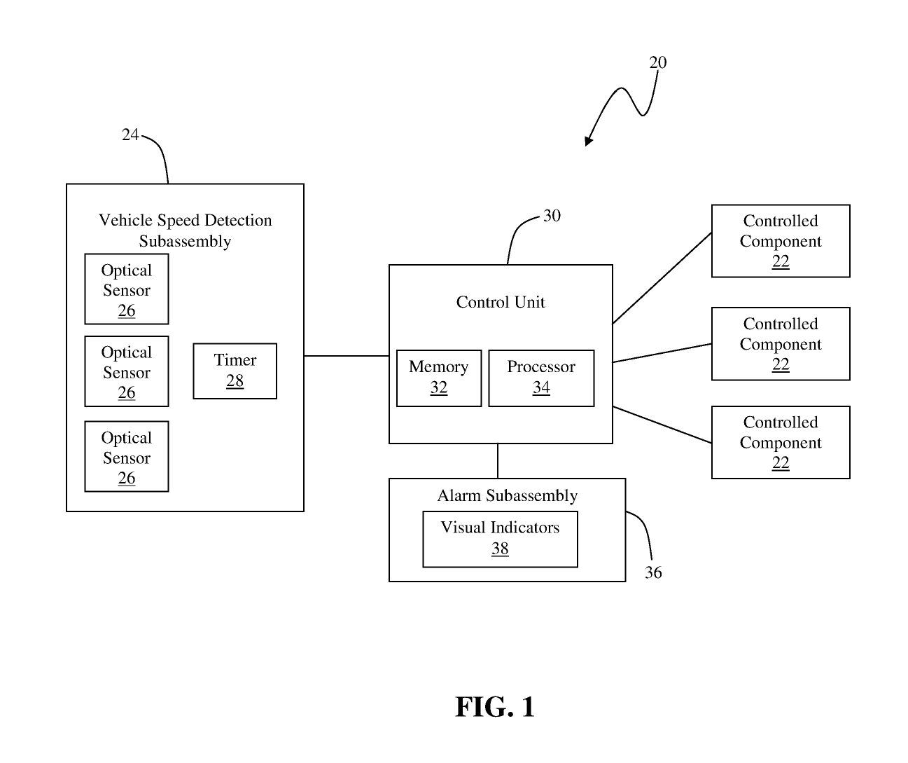

Referring to the Figures, wherein like numerals indicate corresponding parts throughout the several views, a washing system 20 for vehicles constructed in accordance with aspects of the disclosure is disclosed. According to an aspect, the washing system 20 (FIG. 1) can include an entrance end where vehicles can enter the washing system 20 and an exit end where vehicles can exit the washing system 20. A vehicle treatment area can extend through the washing system 20 from the entrance to the exit. The washing system 20 may be disposed inside a freestanding enclosure such as a building, however, it should be appreciated that the washing system 20 could be located inside another structure such as a parking garage, or even be constructed without an enclosure. According to an aspect, the washing system 20 may be particularly suited for use by owners of fleet vehicles. However, it will be appreciated that the system 20 can also be employed with commercial wash facilities.

A plurality of controllable treatment components 22 (FIG. 1) may be disposed along the vehicle treatment area of the washing system 20 for washing the vehicles. According to an aspect of the disclosure, the controllable treatment components 22 can include rollers, mitters, brushes, wheels, sprayers, mixers, valves, liquid delivery subsystems, and blowers. However, it should be understood that the washing system 20 may include additional controllable treatment components 22 or a subset of those described above. The controllable components 22 and their configuration may be selected and sized based on the types of vehicles that are intended to be washed in the washing system 20 and may, for example, include larger controllable components 22 or more sprayers if the washing system 20 will be primarily used to wash large trucks instead of smaller passenger vehicles. It will also be appreciated that the order and sequence of controllable components 22 along the vehicle treatment area between the entrance end and the exit end may vary.

According to an aspect of the disclosure, the system 20 can include a vehicle speed detection subassembly 24 (FIG. 1) that can sense the speed of the vehicles travelling through the washing system 20 and output a signal proportional to the speed of the vehicles. According to an aspect, the vehicle speed detection subassembly 24 can include a plurality of optical sensors 26 disposed at spaced intervals along the vehicle treatment area of travel of the washing system 20 for detecting the vehicle being located adjacent each of the optical sensors 26. According to this aspect, two optical sensors 26 could be utilized with one of the sensors located adjacent the entrance end and another located adjacent the exit end. The vehicle speed detection subassembly 24 can also include a timer 28 for determining the duration of time that the vehicle is in the washing system 20, i.e., between the optical sensors 26. Consequently, the vehicle speed detection subassembly 24 can determine the speed of the vehicle since the distance between the optical sensors 26 is known and vehicle speed can be determined as the vehicle presence is detected by one of the optical sensors 26 and later by another nearby optical sensor 26. The distance covered per the determined elapsed time equals the average speed over that distance (i.e., between the optical sensors 26). The vehicle speed detection subassembly 24 could carry out this calculation via a myriad of components, such as, but not limited to analog circuitry, microprocessors, logic gates, or gate arrays. A variety of other suitable structures and methods for measuring or determining vehicle speed may also be employed. It will also be appreciated that the optical sensors 26 could be in communication with a controller or control system such that the vehicle speed information could be tracked and recorded. It will further be appreciated that any number of optical sensors 26 could be utilized.

According to another aspect of the disclosure, the vehicle speed detection subassembly 24 could include at least one micro switch activated by the passage of the vehicle rather than or in combination with optical sensors 26. The micro switch could for example be located near the entrance end of the washing system 20. While the washing system 20 according to one aspect of the disclosure may be configured to allow vehicles to travel through the vehicle treatment area under their own power, the washing system 20 could alternatively use a conveyor system wherein the vehicle speed detection subassembly 24 could monitor the speed of the conveyor. The vehicle speed detection subassembly 24 may use any type of sensing mechanism, such as, but not limited to laser speed detection, radar, photo, or Hall Effect sensors. In other words, the washing system 20 of the disclosure is not limited in how the speed of the vehicle is detected.

According to an aspect, a control unit 30 (FIG. 1) can have a memory 32 and a processor 34 that is coupled with the vehicle speed detection subassembly 24 and the controllable components 22. According to an aspect of the disclosure, the control unit 30 may be electrically connected to the vehicle speed detection subassembly 24 and the controllable components 22. However, it should be appreciated that the control unit 30 may be coupled or connected to the vehicle speed detection subassembly 24 and the controllable components 22 in some other manner, such as, but not limited to a wireless connection. The control unit 30 can control the controllable components 22 of the washing system 20 based on the received signal from the vehicle speed detection subassembly 24. The control unit 30 can also direct operation of the controllable components based on a variety of other factors. According to an aspect, the memory 32 of the control unit 30 may be configured to store a predetermined maximum speed as well as the signals from the vehicle speed detection subassembly 24. The predetermined maximum speed may be configured or selected by the end user or owner of the washing system 20 and may depend on the types of controllable components 22 being used in the washing system 20 or the types of vehicles washed in the washing system 20. It will be appreciated that system 20 can include any number of detection devices and that they can be disposed in a variety of suitable places along the vehicle treatment area.

According to an aspect, the processor 34 of the control unit 30 may be configured to compare the signal from the vehicle speed detection subassembly 24 to the predetermined maximum speed stored in the memory unit 32 and simultaneously turn off all the controllable components 22 of the washing system 20 in response to the signal from the vehicle speed detection subassembly 24 indicating that the predetermined maximum speed has been exceeded. Consequently, the memory 32 of the control unit 30 can also store a predetermined shutdown time that may also be configurable by the owner of the washing system 20. While the vehicle speed detection subassembly 24 may output a signal indicative of the speed of the vehicle, it should be understood that the processor 34 of the control unit 30 could alternatively be coupled to the sensors or switches of the vehicle speed detection subassembly 24 and may carry out the calculation itself to determine the speed of the vehicle rather than the calculation being carried out by a separate circuit, array of logic gates, or microprocessor. Additionally, though the washing system 20 according to one aspect of the disclosure can include a single control unit 30, it should be appreciated that the washing system 20 may include more than one control unit 30. According to another aspect, the control unit 30 could be located off-site, or even integrated in the vehicles themselves.

According to an aspect, the system 20 can include an alarm subassembly 36 (FIG. 1) including visual indicators 38 (e.g. lights) for alerting a driver of the vehicle of certain conditions. According to an aspect of the disclosure, the alarm subassembly 36 can be controlled by the processor 34 of the control unit 30 and may be configured to alert the driver of the vehicle using the visual indicators 38 in response to the signal from the vehicle speed detection subassembly 24 exceeding the predetermined maximum speed. The visual indications may consist of lights disposed on the controllable components 22 or otherwise located in the system 20 such that they can be seen by drivers in the vehicle treatment area. According to another aspect of the disclosure, the alarm subassembly 36 could also include an audible or other sensory alert that can be implemented based on the signal from the vehicle speed subassembly indicating that the predetermined maximum speed threshold has been exceeded prior to the control unit 30 turning off all controlled components 22. That is to say, the system 20 can allow some time for the driver of the vehicle to adjust their speed in response to one or more alerts or alarms prior to the washing system 20 being shut down. While the washing system 20 may include the alarm subassembly 36, it should additionally be understood that the washing system 20 may also be alternatively configured without the alarm subassembly 36.

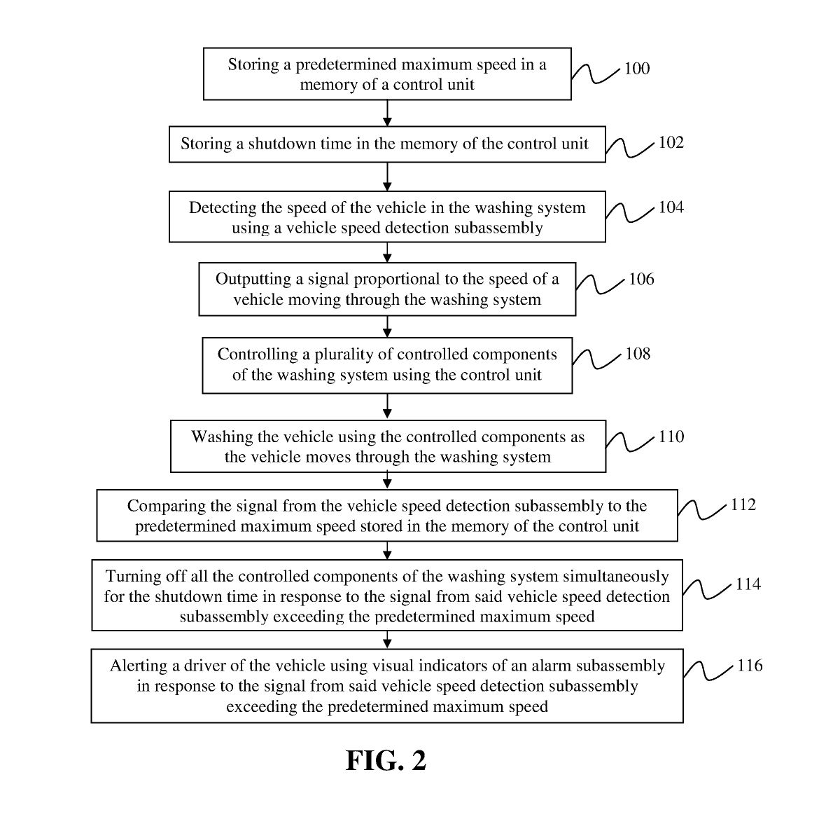

Referring now to FIG. 2, an exemplary method of operating a washing system 20 for vehicles is also disclosed. The method can include the steps of storing a predetermined maximum speed threshold in a memory 32 of a control unit 30 as generally indicated by 100 and storing a shutdown time in the memory 32 of the control unit 30 as generally indicated by 102. It will also be appreciated that multiple speed thresholds can be employed. At one threshold an alarm or alert can be deployed while at another threshold the system could be shut down. As mentioned herein, the use of alarms or alerts can be used together with the shutting off the controllable components 22 or they may be separate individual actions. The method can proceed by detecting the speed of the vehicle in the washing system 20 using a vehicle speed detection subassembly 24 as generally indicated by 104. Next, a signal proportional to the speed of a vehicle moving through the washing system 20 can be output as generally indicated by 106. The next step of the method can include controlling a plurality of controllable components 22 of the washing system 20 using the control unit 30 as indicated by 108. The method can continue by washing the vehicle using the controllable components 22 as the vehicle moves through the washing system 20 as indicated by 110 and comparing the signal from the vehicle speed threshold detection subassembly 24 to the predetermined maximum speed stored in the memory 32 of the control unit 30 as indicated by 112.

The next step is can include turning off all the controllable components 22 of the washing system 20 simultaneously for the preset shutdown time in response to the signal from the vehicle speed detection subassembly 24 indicating that the predetermined maximum speed threshold had been met as indicated by 114. Finally, the method can conclude by alerting a driver of the vehicle using visual indicators 38 in response to the signal from the vehicle speed detection subassembly 24 indicating that the predetermined maximum speed threshold was met as indicated by 116. As mentioned herein, the use of alarms or alerts can be used together with shutting off the controllable components 22 or they may be separate individual actions.

As is known, vehicles being washed at companies using a fleet of vehicles (e.g., rental car and truck companies, trucking companies, etc.) are commonly lined up by the drivers (e.g. porters) to be washed and the porters generally desire to move the vehicles through the washing system 20 quickly. So according to one illustrative example, the system 20 can shut off the components 22 due to a vehicle exceeding the maximum speed threshold in the wash portion of wash. In this aspect, because the vehicle is generally rinsed and dried near the end of the wash, the driver of the vehicle moving too quickly through the washing system 20 would need to exit the wash system 20 and go to the back of the line in order rewash and dry the vehicle. The risk of losing time going back through the line may effectively be a penalty to the porter or driver if he or she is attempting to process as many vehicles as possible. Therefore, the washing system 20 disclosed herein can provide the advantage of effectively persuading drivers or porters to adjust their speed to wash the vehicle without damaging the washing system 20 or the vehicle.

It is also known that excess speed through a wash system can cause damage to the controllable components 22 or a vehicle exterior. Some wash operators may be inclined to speed up a conveyer on a sunny spring day to increase revenue at the expense of a good vehicle wash or possible damage to the system or the vehicles. The disclosed system can minimize these issues.

Note that not all of the activities described above in the general description or the examples are required, that a portion of a specific activity may not be required, and that one or more further activities may be performed in addition to those described. Still further, the orders in which activities are listed are not necessarily the order in which they are performed.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Many other embodiments may be apparent to those of skill in the art upon reviewing the disclosure. Other embodiments may be used and derived from the disclosure, such that a structural substitution, logical substitution, or another change may be made without departing from the scope of the disclosure. Accordingly, the disclosure is to be regarded as illustrative rather than restrictive.

Certain features are, for clarity, described herein in the context of separate embodiments, may also be provided in combination in a single embodiment. Conversely, various features that are, for brevity, described in the context of a single embodiment, may also be provided separately or in any sub combination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A vehicle wash system, comprising:
a control system including a predetermined vehicle speed threshold;
a plurality of vehicle treatment components disposed adjacent a vehicle treatment area and in communication with the control system;
at least one detection mechanism disposed adjacent the vehicle treatment area and configured to communicate with a vehicle in the vehicle treatment area to obtain vehicle data; the at least one detection mechanism in communication with the control system;
whereby the control system is configured to receive the vehicle data and determine an actual vehicle speed;
whereby the control system is further configured to compare the actual vehicle speed to the predetermined vehicle speed threshold and if the actual speed meets or exceeds the predetermined vehicle speed threshold, a predetermined control action can be implemented.

2. The system of claim 1, wherein the control action includes stopping operation of the plurality of vehicle wash components.

3. The system of claim 1, wherein the control action includes activating one or more visual indicators adjacent the vehicle treatment area.

4. The system of claim 3, wherein the visual indicators are lights disposed on the plurality of vehicle treatment components.

5. The system of claim 1, further comprising:
a plurality of detection mechanism.

6. The system of claim 5, wherein the plurality of detection mechanism consist of optical sensors.

7. The system of claim 1, wherein the vehicle data includes a vehicle speed.

8. A vehicle wash system comprising:
a plurality of vehicle treatment components disposed adjacent a vehicle treatment area;
at least one sensing mechanism disposed adjacent the vehicle treatment area and configured to obtain vehicle data;
a controller in communication with the at least one sensing mechanism and configured to implement a control action if the vehicle data is indicative of a condition where an actual vehicle speed satisfies a vehicle speed threshold.

9. The system of claim 8, wherein the controller is incorporated into the at least one sensing mechanism.

10. The system of claim 8, wherein the controller is part of a control system.

11. The system of claim 8, wherein the controller is in communication with the plurality of vehicle treatment components and the control action includes shutting down operation of the vehicle treatment components.

12. The system of claim 8, wherein the sensing mechanism is selected from one or more of an optical sensor, a laser speed detector, or a photo eye.

13. The system of claim 8, further comprising:
a plurality of sensing mechanisms including at least one sensing mechanism located at an entrance end of the vehicle treatment area.

14. The system of claim 8, wherein the controller includes first and second predetermined speed thresholds stored thereon and first and second control actions associated with each of the first and second predetermined speed thresholds.

15. The system of claim 14, wherein the first predetermined speed threshold is less than the second predetermined speed threshold and the first control action includes implementation of an alert.

16. The system of claim 15, wherein the first control action directs lights disposed adjacent the vehicle treatment area to illuminate.

17. The system of claim 15, wherein the first control action causes an audible alert to occur.

18. The system of claim 15, wherein the second control action includes shutting down operation of the vehicle treatment components.

19. The system of claim 8, wherein the vehicle data includes a conveyer speed.

20. A vehicle wash system, comprising:
a plurality of vehicle wash components disposed adjacent a vehicle treatment area;
a plurality of sensing mechanism disposed adjacent a vehicle treatment area configured to obtain vehicle data relevant to an actual vehicle speed;
a control system in communication with the plurality of sensing mechanism to receive the vehicle data;
the control system further in communication with the plurality of vehicle wash components to cease operation thereof in response to the actual vehicle speed meeting a first stored vehicle speed threshold

21. The system of claim 20, wherein the vehicle data is representative of the actual vehicle speed.

22. The system of claim 20, wherein the vehicle data is representative of a time a vehicle traveled between two adjacent sensing mechanism.

23. The system of claim 20, wherein the vehicle data is representative of a conveyor speed.

24. The system of claim 20, wherein the control system further includes a second stored vehicle speed threshold, which is less than the first stored vehicle speed threshold: and
wherein the control system includes a control action associated with the second stored vehicle speed threshold.

25. The system of claim 24, wherein the control action involves activating an audible or visual alarm.
